(19) United States
(12) Patent Application Publication
(10) Pub. No.: US 2026/0091822 A1
(43) Pub. Date: Apr. 2, 2026

(54) VEHICLE DRIVER ASSISTANCE DEVICE, VEHICLE DRIVER ASSISTANCE METHOD, AND STORAGE MEDIUM

(71) Applicant: TOYOTA JIDOSHA KABUSHIKI KAISHA, Toyota-shi (JP)

(72) Inventor: Keiko SAKURAI, Toyota-shi (JP)

(73) Assignee: TOYOTA JIDOSHA KABUSHIKI KAISHA, Toyota-shi (JP)

(21) Appl. No.: 19/256,526

(22) Filed: Jul. 1, 2025

(30) Foreign Application Priority Data
Oct. 2, 2024 (JP) 2024-173267

(51) Int. Cl. B62D 15/02

(52) U.S. Cl. CPC B62D 15/025

(57) ABSTRACT

A vehicle driver assistance device provides a warning or steering assistance for reducing deviation of a host vehicle from a lane. The vehicle driver assistance device starts the warning or the steering assistance when the host vehicle reaches an assistance start line set along a lane marking defining the lane. The vehicle driver assistance device stores, as a deviation point, a point at which the host vehicle has reached the assistance start line, and stores, as a deviation amount, an amount by which the host vehicle has crossed the assistance start line at the deviation point, and when the host vehicle is traveling at the deviation point and the host vehicle has reached the assistance start line at the deviation point a predetermined number of times or more, shifts the assistance start line away from the center of the lane according to the stored deviation amount.

### CROSS-REFERENCE TO RELATED APPLICATION

This application claims priority to Japanese Patent Application No. 2024-173267 filed on Oct. 2, 2024. The disclosure of the above-identified application, including the specification, drawings, and claims, is incorporated by reference herein in its entirety.

### BACKGROUND

### 1. Technical Field

The present disclosure relates to vehicle driver assistance devices, vehicle driver assistance methods, and storage media.

### 2. Description of Related Art

There is known a technique for reducing deviation of a host vehicle from its lane by providing a warning when the host vehicle is about to deviate from its lane. There is also known a technique for not providing a warning when a host vehicle is traveling at a point where it frequently changes lanes, even if the host vehicle is about to deviate from its lane (see, for example, Japanese Unexamined Patent Application Publication No. 2005-18211 (JP 2005-18211 A)). This technique reduces the possibility that the driver may feel annoyed by an undesired warning.

### SUMMARY

Even when a host vehicle is traveling at a point where it frequently changes lanes, the host vehicle may deviate from its lane without the intention of changing lanes. In the above technique, however, no warning is provided even in such a situation. Therefore, it is not possible to appropriately reduce deviation of the host vehicle from its lane.

An object of the present disclosure is to provide a vehicle driver assistance device and a vehicle driver assistance method that can appropriately reduce deviation of a host vehicle from its lane, and a storage medium storing a vehicle driver assistance program that can appropriately reduce deviation of a host vehicle from its lane.

A vehicle driver assistance device according to the present disclosure includes a control device configured to provide a warning or steering assistance for reducing deviation of a host vehicle from a lane.

The control device is configured to start the warning or the steering assistance when the host vehicle reaches an assistance start line set along a lane marking defining the lane.

The control device is configured to store, as a deviation point, a point at which the host vehicle has reached the assistance start line, and store, as a deviation amount, an amount by which the host vehicle has crossed the assistance start line at the deviation point.

The control device is configured to, when the host vehicle is traveling at the deviation point and the number of times the host vehicle has reached the assistance start line at the deviation point is a predetermined number of times or more, shift the assistance start line in a direction away from the center of the lane according to the stored deviation amount.

In the present disclosure, the warning or the steering assistance is less likely to be provided at a point where an operator voluntarily causes the host vehicle to deviate from its lane. This can reduce the possibility of annoying the operator by providing an undesired warning or steering assistance. It is therefore possible to appropriately reduce deviation of the host vehicle from its lane.

In the vehicle driver assistance device according to the present disclosure, the control device may be configured to, when the host vehicle is traveling at the deviation point and the number of times the host vehicle has reached the assistance start line at the deviation point is the predetermined number of times or more, shift the assistance start line in the direction away from the center of the lane in such a manner that the assistance start line is located farther away from the center of the lane as the stored deviation amount increases.

In the present disclosure, the larger the stored deviation amount, the more the assistance start line is shifted. This can more reliably reduce the possibility of annoying the operator by providing an undesired warning or steering assistance.

In the vehicle driver assistance device according to the present disclosure, the control device may be configured to store neither a point at which the host vehicle has crossed the assistance start line to ensure the safety of the host vehicle nor an amount by which the host vehicle has crossed the assistance start line at the point.

In the present disclosure, when the host vehicle has crossed the assistance start line to ensure the safety of the host vehicle, neither the point at which the host vehicle has crossed the assistance start line nor the amount by which the host vehicle has crossed the assistance start line at the point is stored. Therefore, the assistance start line will not be shifted when the host vehicle has crossed the assistance start line to ensure the safety of the host vehicle. Accordingly, it is possible to appropriately reduce deviation of the host vehicle from its lane.

A vehicle driver assistance method according to the present disclosure is a method for providing a warning or steering assistance for reducing deviation of a host vehicle from a lane. The vehicle driver assistance method is configured to start the warning or the steering assistance when the host vehicle reaches an assistance start line set along a lane marking defining the lane. The vehicle driver assistance method includes:

storing, as a deviation point, a point at which the host vehicle has reached the assistance start line, and storing, as a deviation amount, an amount by which the host vehicle has crossed the assistance start line at the deviation point; and
when the host vehicle is traveling at the deviation point and the number of times the host vehicle has reached the assistance start line at the deviation point is a predetermined number of times or more, shifting the assistance start line in a direction away from the center of the lane according to the stored deviation amount.

The present disclosure can appropriately reduce deviation of the host vehicle from its lane.

A storage medium according to the present disclosure stores a vehicle driver assistance program configured to provide a warning or steering assistance for reducing deviation of a host vehicle from a lane. The vehicle driver assistance program is configured to start the warning or the steering assistance when the host vehicle reaches an assistance start line set along a lane marking defining the lane.

The vehicle driver assistance program is configured to

store, as a deviation point, a point at which the host vehicle has reached the assistance start line, and store, as a deviation amount, an amount by which the host vehicle has crossed the assistance start line at the deviation point, and
when the host vehicle is traveling at the deviation point and the number of times the host vehicle has reached the assistance start line at the deviation point is a predetermined number of times or more, shift the assistance start line in a direction away from the center of the lane according to the stored deviation amount.

The present disclosure can appropriately reduce deviation of the host vehicle from its lane.

The components of the present disclosure are not limited to the embodiment of the present disclosure described later with reference to the drawings. Other objects, other features, and accompanying advantages of the present disclosure will be readily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle driver assistance device according to an embodiment of the present disclosure;

FIG. 2 is a view showing a first line etc.;

FIG. 3 is a flowchart illustrating a routine that is executed by the vehicle driver assistance device according to the embodiment of the present disclosure;

FIG. 4 is a flow chart showing a routine that is executed by the vehicle driver assistance device according to the embodiment of the present disclosure; and

FIG. 5 is a flowchart illustrating a routine that is executed by the vehicle driver assistance device according to the embodiment of the present disclosure.

### DETAILED DESCRIPTION OF EMBODIMENTS

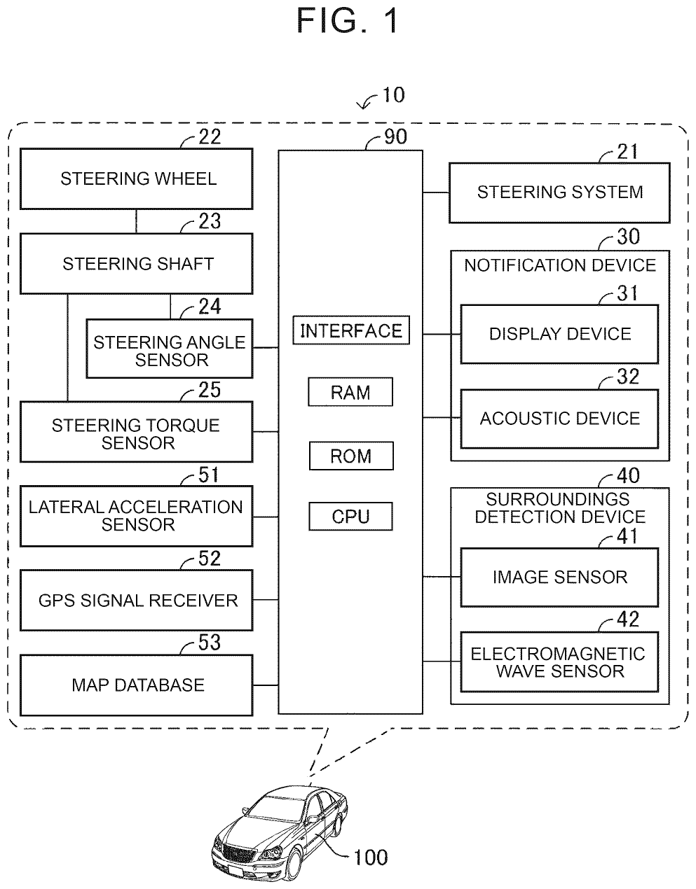

Hereinafter, a vehicle driver assistance device, a vehicle driver assistance method, and a vehicle driver assistance program according to an embodiment of the present disclosure will be described with reference to the drawings. In FIG. 1, a vehicle driver assistance device 10 according to the embodiment of the present disclosure is shown. The vehicle driver assistance device 10 is mounted on a host vehicle 100. Hereinafter, the vehicle driver assistance device 10 will be described by taking a case where an operator of the host vehicle 100 is a driver of the host vehicle 100 (that is, a person who rides on the host vehicle 100 and drives the host vehicle 100) as an example. However, the operator of the host vehicle 100 may be a remote operator of the host vehicle 100 (that is, a person who drives the host vehicle 100 remotely without getting on the host vehicle 100).

As shown in FIG. 1, the vehicle driver assistance device 10 includes an electronic control unit (ECU) 90 as a control device. The ECU 90 includes a microcomputer as a main part. The microcomputer includes a CPU, a computer-readable storage medium, an interface, and the like. The storage medium is a ROM, RAM, a nonvolatile memory, or the like. The CPU implements various functions by executing instructions, programs, or routines stored in the storage medium. In particular, in this example, the vehicle driver assistance device 10 stores programs for implementing various controls executed by the vehicle driver assistance device 10 in the storage medium.

In the present embodiment, the vehicle driver assistance device 10 includes only one ECU 90, but may include a plurality of ECUs, and may be configured to share the functions of the vehicle driver assistance device 10 described below by the ECUs.

Further, the vehicle driver assistance device 10 may be configured to be able to update the programs stored in the storage medium by wireless communication with an external device (for example, Internet communication).

The vehicle driver assistance device 10 is applied not only to a vehicle traveled by manual driving by an operator, but also to a vehicle traveled by autonomous driving in addition to manual driving.

The host vehicle 100 is equipped with a steering device 21, a steering wheel 22, a steering shaft 23, a steering angle sensor 24, and a steering torque sensor 25.

The steering device 21 is a device that applies a steering force (steering torque) for steering the host vehicle 100 to the host vehicle 100. The steering wheel 22 is a device operated by a driver to steer the host vehicle 100. The steering wheel 22 is connected to the steering shaft 23. The driver can rotate the steering shaft 23 by rotating the steering wheel 22. The steering angle sensor 24 is a sensor for detecting the steering angle θ. The steering angle θ is a rotation angle of the steering shaft 23 from the neutral position. The steering torque sensor 25 is a sensor for detecting a driver input torque TQdrv. The driver input torque TQdrv is a torque input from the steering wheel 22 to the steering shaft 23 by the driver of the host vehicle 100.

The steering device 21, the steering angle sensor 24, and the steering torque sensor 25 are electrically connected to the ECU 90. The vehicle driver assistance device 10 acquires the steering angle θ by the steering angle sensor 24. In addition, the vehicle driver assistance device 10 acquires the driver input torque TQdrv by the steering torque sensor 25. The vehicle driver assistance device 10 steers the host vehicle 100 by controlling the operation of the steering device 21 according to the acquired steering angle θ and driver input torque TQdrv.

Furthermore, the host vehicle 100 is equipped with a notification device 30. The notification device 30 includes a display device 31 and an acoustic device 32.

The display device 31 is a device that displays various images. The display device 31 includes, for example, a display. The display device 31 is electrically connected to the ECU 90. The vehicle driver assistance device 10 displays various images by the display device 31.

The acoustic device 32 is a device that outputs various sounds and/or sounds. The acoustic device 32 includes, for example, a speaker. The acoustic device 32 is electrically connected to the ECU 90. The vehicle driver assistance device 10 outputs various sounds and/or sounds by the acoustic device 32.

Further, the host vehicle 100 is equipped with a surroundings detection device 40, a lateral acceleration sensor 51, a GPS receiver 52, and a map database 53.

The surroundings detection device 40 is a device that detects information on the surroundings of the host vehicle 100. The surroundings detection device 40 includes a plurality of image sensors 41 and a plurality of electromagnetic wave sensors 42.

The image sensor 41 is a sensor that captures an image of the surroundings of the host vehicle 100. The image sensor 41 is, for example, a camera sensor. The image sensor 41 is electrically connected to the ECU 90. The vehicle driver assistance device 10 acquires the image data or the image information of the surroundings of the host vehicle 100 as the surroundings information IS by the image sensors 41.

The electromagnetic wave sensor 42 is a sensor for acquiring information on a target around the host vehicle 100. The electromagnetic wave sensor 42 is, for example, a millimeter wave radar. The electromagnetic wave sensor 42 is electrically connected to the ECU 90. The vehicle driver assistance device 10 acquires target data or target information on a target around the host vehicle 100 as the surroundings information IS by the electromagnetic wave sensors 42.

The lateral acceleration sensor 51 is a sensor for detecting the lateral acceleration G. The lateral acceleration G is an acceleration in the lateral direction of the host vehicle 100. The lateral acceleration sensor 51 is electrically connected to the ECU 90. The vehicle driver assistance device 10 acquires the lateral acceleration G by the lateral acceleration sensor 51.

GPS signal receiver 52 is a device that receives a GPS signal. GPS receiver 52 is electrically connected to the ECU 90. The vehicle driver assistance device 10 receives GPS signal via GPS signal receiver 52. The vehicle driver assistance device 10 acquires the current location Pnow of the host vehicle 100 based on GPS signal.

The map database 53 is a device that stores map information IM. The map database 53 is electrically connected to the ECU 90. The vehicle driver assistance device 10 acquires the map information IM from the map database 53.

### Operation of Vehicle Driver Assistance Device

Next, the operation of the vehicle driver assistance device 10 will be described. The vehicle driver assistance device 10 provides a warning and steering assistance in order to reduce deviation of the host vehicle 100 from the lane LN.

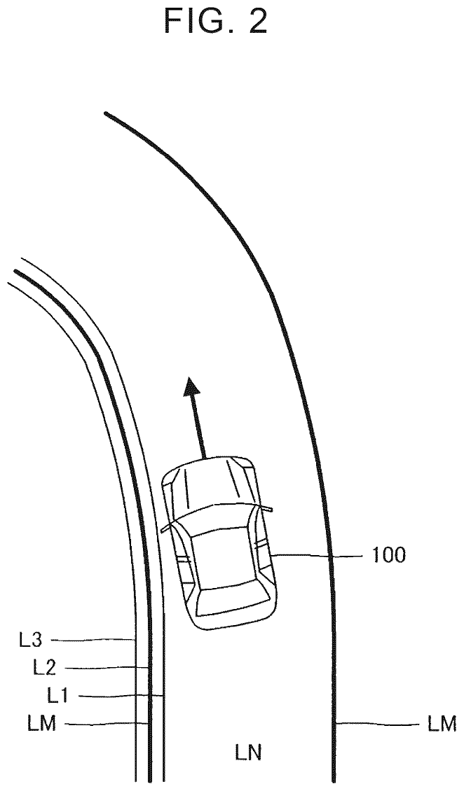

In the present embodiment, as shown in FIG. 2, a first line L1, a second line L2, and a third line L3 are set as the assistance start lines along the lane marking LM. In the present embodiment, the first line L1 is set to be inside by a predetermined distance (first distance d1) from the lane marking LM defining the lane LN. That is, the first line L1 is set in the lane LN. The second line L2 is set on the lane marking LM. The third line L3 is set outward by a predetermined distance (third distance d3) from the lane marking LM. That is, the third line L3 is set outside the lane LN. The first distance d1 and the third distance d3 may be the same distance or may be different distances.

Only the first line L1, the second line L2, and the third line L3 with respect to the left lane marking LM defining the lane LN are illustrated in FIG. 2. However, in the present embodiment, the first line L1, the second line L2, and the third line L3 are also set with respect to the right lane marking LM defining the lane LN.

When the host vehicle 100 reaches the first line L1, the vehicle driver assistance device 10 provides steering support as steering assistance. The vehicle driver assistance device 10 determines whether the host vehicle 100 has reached the first line L1, based on the surroundings information IS. The steering support is a process of applying a steering assist torque TQast to the steering shaft 23. The steering assist torque TQast is a torque for rotating the steering shaft 23 toward the center of the lane LN of the host vehicle 100. The vehicle driver assistance device 10 provides steering assist torque TQast to the steering shaft 23 by controlling the operation of the steering device 21. The steering assist torque TQast is set so that the driver of the host vehicle 100 can operate the steering wheel 22 against the steering assist torque TQast.

The vehicle driver assistance device 10 provides a warning when the host vehicle 100 reaches the second line L2. The vehicle driver assistance device 10 determines whether the host vehicle 100 has reached the second line L2, based on the surroundings information IS. The warning notifies the driver of the host vehicle 100 that the host vehicle 100 is about to deviate from the lane LN. In this example, the vehicle driver assistance device 10 provides a warning by outputting a buzzer sound or a voice from the acoustic device 32. Alternatively or additionally, the vehicle driver assistance device 10 provides a warning by displaying a predetermined image by the display device 31.

When the host vehicle 100 reaches the third line L3, the vehicle driver assistance device 10 performs the deviation avoidance steering as the steering assistance. The vehicle driver assistance device 10 determines whether the host vehicle 100 has reached the third line L3 based on the surroundings information IS. The deviation avoidance steering is a process of applying a deviation avoidance torque TQdav to the steering shaft 23. The deviation avoidance torque TOdav is a torque for rotating the steering shaft 23 toward the center of the host vehicle 100 in the lane LN. The vehicle driver assistance device 10 provides the deviation avoidance torque TQdav to the steering shaft 23 by controlling the operation of the steering device 21. The deviation avoidance torque TQdav is set so that the driver of the host vehicle 100 can operate the steering wheel 22 against the deviation avoidance torque TQdav. The deviation avoidance torque TQdav is set to be larger than the steering assist torque TQast.

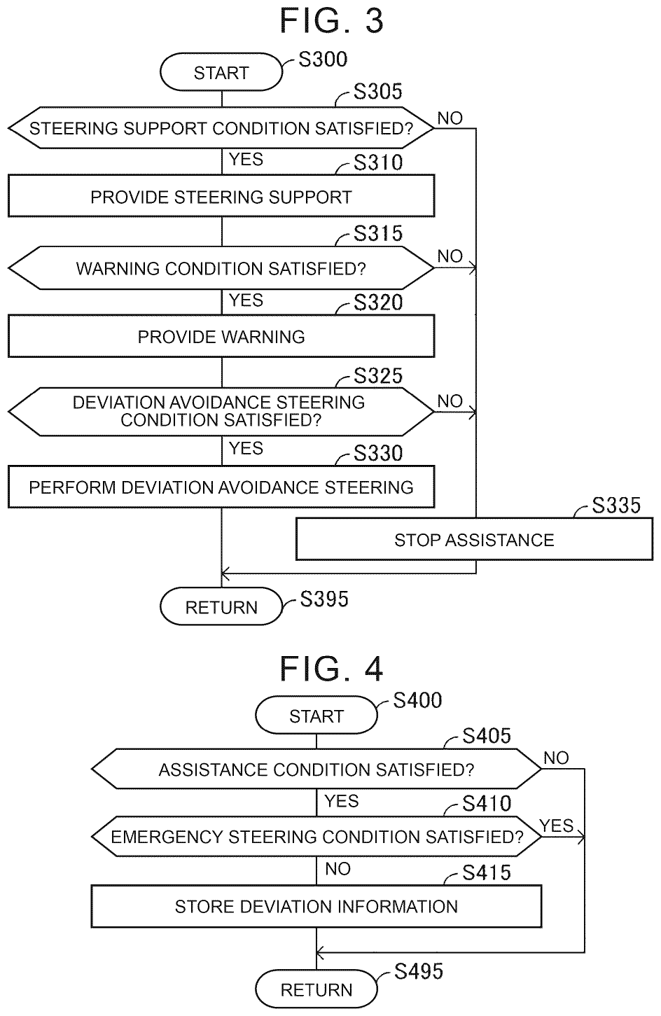

The vehicle driver assistance device 10 executes the routine illustrated in FIG. 3 at predetermined time intervals to provide the warning or steering assistance when a predetermined condition is satisfied. Accordingly, the vehicle driver assistance device 10 starts the process from S300 of the routine illustrated in FIG. 3. Then, the vehicle driver assistance device 10 advances the process to S305, and determines whether a steering support condition C1 is satisfied. The steering support condition C1 is satisfied when the host vehicle 100 reaches the first line L1.

When “Yes” in S305, the vehicle driver assistance device 10 advances the process to S310 and provides steering support. Next, the vehicle driver assistance device 10 advances the process to S315 and determines whether a warning condition C2 is satisfied. The warning condition C2 is satisfied when the host vehicle 100 reaches the second line L2.

When “Yes” in S315, the vehicle driver assistance device 10 advances the process to S320 and provides a warning. Next, the vehicle driver assistance device 10 advances the process to S325, and determines whether a deviation avoidance steering condition C3 is satisfied. The deviation avoidance steering condition C3 is satisfied when the host vehicle 100 reaches the third line L3.

When “Yes” in S325, the vehicle driver assistance device 10 advances the process to S330, stops the steering support, and performs the deviation avoidance steering. Next, the vehicle driver assistance device 10 advances the processing to S395, and ends the processing of the routine once.

On the other hand, when “No” in S305, the vehicle driver assistance device 10 advances the process to S335, and stops the steering support, the warning, and the deviation avoidance steering that are being provided at that time. Next, the vehicle driver assistance device 10 advances the processing to S395, and ends the processing of the routine once.

Similarly, when “No” in S315, the vehicle driver assistance device 10 advances the process to S335, and stops the steering support, the warning, and the deviation avoidance steering that are being provided at that time. Next, the vehicle driver assistance device 10 advances the processing to S395, and ends the processing of the routine once.

Similarly, when “No” in S325, the vehicle driver assistance device 10 advances the process to S335, and stops the steering support, the warning, and the deviation avoidance steering that are being provided at that time. Next, the vehicle driver assistance device 10 advances the processing to S395, and ends the processing of the routine once.

At a predetermined timing, the vehicle driver assistance device 10 starts the process from S400 of the routine illustrated in FIG. 4. Then, the vehicle driver assistance device 10 advances the process to S405 and determines whether an assistance execution condition C4 is satisfied. The assistance execution condition C4 is satisfied when steering support, a warning, or deviation avoidance steering is provided.

When “Yes” in S405, the vehicle driver assistance device 10 advances the process to S410 and determines whether an emergency steering condition C5 is satisfied.

The emergency steering condition C5 is satisfied when the host vehicle 100 reaches the first line L1 in order to ensure the safety of the host vehicle 100. More specifically, the emergency steering condition C5 is satisfied when the lateral acceleration G is equal to or greater than the predetermined value G1 when the host vehicle 100 reaches the first line L1. Alternatively, the emergency steering condition C5 is satisfied when the driver input torque TQdrv is equal to or greater than the predetermined value TQ1 when the host vehicle 100 reaches the first line L1.

It should be noted that securing the safety of the host vehicle 100 is, for example, avoiding a collision between the host vehicle 100 and an obstacle ahead.

Furthermore, the emergency steering condition C5 is also satisfied when the host vehicle 100 reaches the second line L2 in order to ensure the safety of the host vehicle 100. More specifically, the emergency steering condition C5 is satisfied when the lateral acceleration G is equal to or greater than the predetermined value G2 when the host vehicle 100 reaches the second line L2. Alternatively, it is satisfied when the driver input torque TQdrv is equal to or greater than the predetermined value TQ2 when the host vehicle 100 reaches the second line L2.

Furthermore, the emergency steering condition C5 is also satisfied when the host vehicle 100 reaches the third line L3 in order to ensure the safety of the host vehicle 100. More specifically, the emergency steering condition C5 is satisfied when the lateral acceleration G is equal to or greater than the predetermined value G3 when the host vehicle 100 reaches the third line L3. Alternatively, it is satisfied when the driver input torque TQdrv is equal to or greater than the predetermined value TQ3 when the host vehicle 100 reaches the third line L3.

The predetermined values G1, G2 and G3 may be the same value or may be different values. Also, the predetermined values TQ1, TQ2 and TQ3 may be the same value or may be different values. The determination of the emergency steering condition C5 may be omitted.

When “No” in S410, the vehicle driver assistance device 10 advances the process to S415 and stores the deviation information ID in the storage medium. Next, the vehicle driver assistance device 10 advances the processing to S495, and ends the processing of the routine once.

The deviation information ID includes the first location information IP1 and the first deviation amount information ID1 when the host vehicle 100 reaches the first line L1 when the assistance execution condition C4 is satisfied. The first location information IP1 is information on the location of the point at which the host vehicle 100 has reached the first line L1. The vehicle driver assistance device 10 stores information on the current location Pnow of the host vehicle 100 when the host vehicle 100 has reached the first line L1 as the first location information IP1. The first deviation amount information ID1 is information on the largest distance by which the host vehicle 100 has crossed the first line L1 (first deviation amount D1). The vehicle driver assistance device 10 acquires the first deviation amount D1 based on the surroundings information IS.

As described above, the vehicle driver assistance device 10 stores, as the deviation point, the point at which the host vehicle 100 has reached the first line L1. The vehicle driver assistance device 10 also stores, as the first deviation amount D1, an amount by which the host vehicle 100 has crossed the first line L1 at the deviation point.

In addition, the deviation information ID includes the second location information IP2 and the second deviation amount information ID2 when the host vehicle 100 reaches the second line L2 when the assistance execution condition C4 is satisfied. The second location information IP2 is information on the location of the point at which the host vehicle 100 has reached the second line L2. The vehicle driver assistance device 10 stores information on the current location Pnow of the host vehicle 100 when the host vehicle 100 has reached the second line L2 as the second location information IP2. The second deviation amount information ID2 is information on the largest distance by which the host vehicle 100 has crossed the second line L2 (second deviation amount D2). The vehicle driver assistance device 10 acquires the second deviation amount D2 based on the surroundings information IS.

As described above, the vehicle driver assistance device 10 stores, as the deviation point, the point at which the host vehicle 100 has reached the second line L2. The vehicle driver assistance device 10 also stores, as the second deviation amount D2, an amount by which the host vehicle 100 has crossed the second line L2 at the deviation point.

In addition, the deviation information ID includes the third location information IP3 and the third deviation amount information ID3 when the host vehicle 100 reaches the third line L3 when the assistance execution condition C4 is satisfied. The third location information IP3 is information on the location of the point at which the host vehicle 100 has reached the third line L3. The vehicle driver assistance device 10 stores information on the current location Pnow of the host vehicle 100 when the host vehicle 100 has reached the third line L3 as the third location information IP3. The third deviation amount information ID3 is information on the largest distance by which the host vehicle 100 has crossed the third line L3 (third deviation amount D3). The vehicle driver assistance device 10 acquires the third deviation amount D3 based on the surroundings information IS.

As described above, the vehicle driver assistance device 10 stores, as the deviation point, the point at which the host vehicle 100 has reached the third line L3. The vehicle driver assistance device 10 also stores, as the third deviation amount D3, an amount by which the host vehicle 100 has crossed the third line L3 at the deviation point.

On the other hand, when “Yes” in S410, the vehicle driver assistance device 10 directly advances the processing to S495, and ends the processing of this routine once. Therefore, when the emergency steering condition C5 is satisfied, the deviation information ID is not stored.

When “No” in S405, the vehicle driver assistance device 10 directly advances the processing to S495, and ends the processing of this routine.

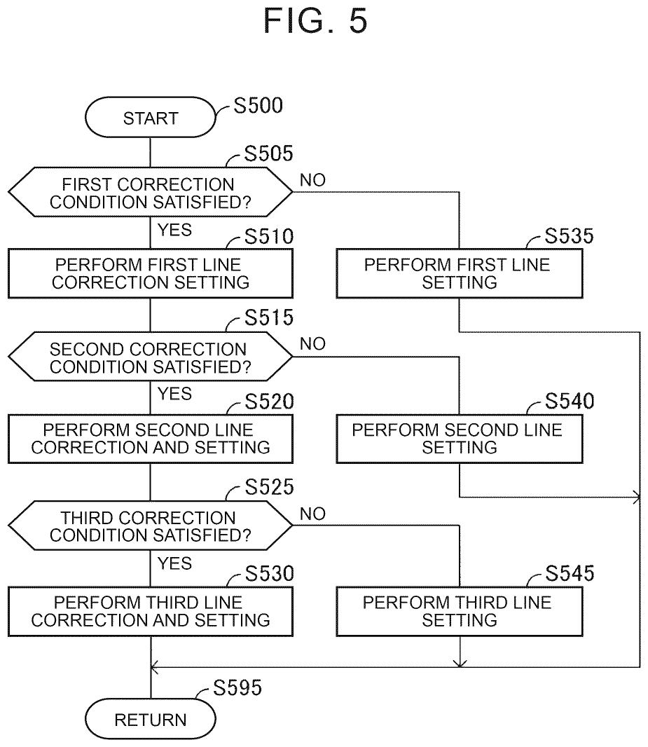

At a predetermined timing, the vehicle driver assistance device 10 starts the process from S500 of the routine illustrated in FIG. 5. Then, the vehicle driver assistance device 10 advances the process to S505, and determines whether a first correction condition CC1 is satisfied. The first correction condition CC1 is satisfied when the host vehicle 100 is traveling on the first deviation point PD1 and a first deviation count ND1 is equal to or greater than a predetermined number of times (first count N1). The first deviation point PD1 is a point indicated by the first location information IP1 stored in the storage medium. The first deviation count ND1 is the number of times that the host vehicle 100 has reached the first line L1 at the first deviation point PD1.

When “Yes” in S505, the vehicle driver assistance device 10 advances the process to S510 and performs the first line correction setting. Next, the vehicle driver assistance device 10 advances the process to S515.

The first line correction setting is a process of setting the first line L1 at a position corrected according to the first deviation amount D1 stored in the storage medium. In other words, the first line correction setting is a process of shifting the first line L1 away from the center of the lane LN according to the first deviation amount D1. In the present embodiment, the first line correction setting is a process of setting the first line L1 to a position displaced outward from the first reference position P1 according to the largest value of the first deviation amount D1. In particular, the first line correction setting is a process of setting the first line L1 at a position displaced from the first reference position P1 to the outer side as the largest value of the first deviation amount D1 increases. An upper limit may be provided for the displacement of the first line L1 from the first reference position P1.

In the present embodiment, the outer side is a side away from the center of the lane LN. The first deviation amount D1 is stored in association with the first location information IP1 indicating the point at which the host vehicle 100 is currently traveling. The first reference position P1 is the position of the first line L1 set when the host vehicle 100 is traveling at a point other than the point indicated by the first location information IP1.

When the process proceeds to S515, the vehicle driver assistance device 10 determines whether a second correction condition CC2 is satisfied. The second correction condition CC2 is satisfied when the host vehicle 100 is traveling on the second deviation point PD2 and a second deviation count ND2 is equal to or greater than a predetermined number of times (second count N2). The second deviation point PD2 is a point indicated by the second location information IP2 stored in the storage medium. The second deviation count ND2 is the number of times that the host vehicle 100 has reached the second line L2 at the second deviation point PD2.

When “Yes” in S515, the vehicle driver assistance device 10 advances the process to S520 and performs the second line correction setting. Next, the vehicle driver assistance device 10 advances the process to S525.

The second line correction setting is a process of setting the second line L2 at a position corrected according to the second deviation amount D2 stored in the storage medium. In other words, the second line correction setting is a process of shifting the second line L2 away from the center of the lane LN according to the second deviation amount D2. In the present embodiment, the second line correction setting is a process of setting the second line L2 at a position displaced outward from the second reference position P2 according to the largest value of the second deviation amount D2. In particular, the second line correction setting is a process of setting the second line L2 to a position displaced outward from the second reference position P2 as the second deviation amount D2 increases. An upper limit may be provided to an amount by which the second line L2 is displaced from the second reference position P2.

The second deviation amount D2 is stored in association with the second location information IP2 indicating the point at which the host vehicle 100 is currently traveling. The second reference position P2 is a position of the second line L2 set when the host vehicle 100 is traveling at a point other than the point indicated by the second location information IP2.

When the process proceeds to S525, the vehicle driver assistance device 10 determines whether a third correction condition CC3 is satisfied. The third correction condition CC3 is satisfied when the host vehicle 100 is traveling on the third deviation point PD3 and the third deviation count ND3 is equal to or greater than a predetermined number of times (third count N3). The third deviation point PD3 is a point indicated by the third location information IP3 stored in the storage medium. The third deviation count ND3 is the number of times that the host vehicle 100 has reached the third line L3 at the third deviation point PD3.

The first count N1, the second count N2, and the third count N3 may be the same value or may be different values.

When “Yes” in S525, the vehicle driver assistance device 10 advances the process to S530 and performs the third line correction setting. Next, the vehicle driver assistance device 10 advances the processing to S595, and ends the processing of the routine once.

The third line correction setting is a process of setting the third line L3 at a position corrected according to the third deviation amount D3 stored in the storage medium. In other words, the third line correction setting is a process of shifting the third line L3 away from the center of the lane LN according to the third deviation amount D3. In the present embodiment, the third line correction setting is a process of setting the third line L3 at a position displaced outward from the third reference position P3 according to the largest value of the third deviation amount D3. In particular, the third line correction setting is a process of setting the third line L3 at a position displaced from the third reference position P3 to the outer side larger as the third deviation amount D3 increases. An upper limit may be provided to an amount by which the third line L3 is displaced from the third reference position P3.

The third deviation amount D3 is stored in association with the third location information IP3 indicating the point at which the host vehicle 100 is currently traveling. The third reference position P3 is a position of the third line L3 set when the host vehicle 100 is traveling at a point other than the point indicated by the third location information IP3.

On the other hand, when “No” in S505, the vehicle driver assistance device 10 advances the process to S535 and performs the first line setting. Next, the vehicle driver assistance device 10 advances the processing to S595, and ends the processing of the routine once.

The first line setting is a process of setting the first line L1 at the first reference position P1, setting the second line L2 at the second reference position P2, and setting the third line L3 at the third reference position P3.

When “No” in S515, the vehicle driver assistance device 10 advances the process to S540 and performs the second line setting. Next, the vehicle driver assistance device 10 advances the processing to S595, and ends the processing of the routine once.

The second line setting is a process of setting the second line L2 at the second reference position P2 and setting the third line L3 at the third reference position P3.

When “No” in S525, the vehicle driver assistance device 10 advances the process to S545 and performs the third line setting. Next, the vehicle driver assistance device 10 advances the processing to S595, and ends the processing of the routine once.

The third line setting is a process of setting the third line L3 in the third reference position P3.

The vehicle driver assistance device 10 may be configured to perform the first line correction setting and the second line correction setting when the first correction condition CC1 is satisfied. The vehicle driver assistance device 10 does not have to determine whether the second correction condition CC2 is satisfied. In addition, the vehicle driver assistance device 10 does not have to store the second location information IP2. In addition, the vehicle driver assistance device 10 may perform the second line correction setting using the first deviation amount D1 instead of the second deviation amount D2. In this case, the vehicle driver assistance device 10 does not have to store the second deviation amount information ID2.

In addition, the vehicle driver assistance device 10 may be configured to perform the first line correction setting and the third line correction setting when the first correction condition CC1 is satisfied. The vehicle driver assistance device 10 does not have to determine whether the third correction condition CC3 is satisfied. In addition, the vehicle driver assistance device 10 does not have to store the third location information IP3. In addition, the vehicle driver assistance device 10 may perform the third line correction setting using the first deviation amount D1 instead of the third deviation amount D3. In this case, the vehicle driver assistance device 10 does not have to store the third deviation amount information ID3.

Further, the vehicle driver assistance device 10 may be configured to perform the second line correction setting and the third line correction setting when the second correction condition CC2 is satisfied. The vehicle driver assistance device 10 does not have to determine whether the third correction condition CC3 is satisfied. In addition, the vehicle driver assistance device 10 does not have to store the third location information IP3. In addition, the vehicle driver assistance device 10 may perform the third line correction setting using the second deviation amount D2 instead of the third deviation amount D3. In this case, the vehicle driver assistance device 10 does not have to store the third deviation amount information ID3.

The determination as to whether the first correction condition CC1 is satisfied may be omitted. In this case, the vehicle driver assistance device 10 is configured to set the first line L1 at a position corrected according to the second deviation amount D2 when the second correction condition CC2 is satisfied. Alternatively, the vehicle driver assistance device 10 is configured to set the first line L1 at a position corrected according to the third deviation amount D3 when the third correction condition CC3 is satisfied. Here, the vehicle driver assistance device 10 does not have to store the first location information IP1 and the first deviation amount information ID1.

The deviation information ID may be stored for each driver. In this case, the first line correction setting or the like is performed for each driver.

The above is the operation of the vehicle driver assistance device 10. The vehicle driver assistance device 10 is less likely to provide a warning or steering assistance at a point where the driver of the host vehicle 100 voluntarily causes the host vehicle 100 to deviate from the lane LN. This can reduce the possibility of annoying the driver by providing an undesired warning or steering assistance. It is therefore possible to appropriately reduce deviation of the host vehicle 100 from the lane LN.

The present disclosure is not limited to the above embodiment, and various modifications can be adopted within the scope of the present disclosure.

What is claimed is:

1. A vehicle driver assistance device including a control device configured to provide a warning or steering assistance for reducing deviation of a host vehicle from a lane, the control device being configured to start the warning or the steering assistance when the host vehicle reaches an assistance start line set along a lane marking defining the lane, wherein the control device is configured to
store, as a deviation point, a point at which the host vehicle has reached the assistance start line, and store, as a deviation amount, an amount by which the host vehicle has crossed the assistance start line at the deviation point, and
when the host vehicle is traveling at the deviation point and the number of times the host vehicle has reached the assistance start line at the deviation point is a predetermined number of times or more, shift the assistance start line in a direction away from a center of the lane according to the stored deviation amount.

2. The vehicle driver assistance device according to claim 1, wherein the control device is configured to, when the host vehicle is traveling at the deviation point and the number of times the host vehicle has reached the assistance start line at the deviation point is the predetermined number of times or more, shift the assistance start line in the direction away from the center of the lane in such a manner that the assistance start line is located farther away from the center of the lane as the stored deviation amount increases.

3. The vehicle driver assistance device according to claim 1, wherein the control device is configured to store neither a point at which the host vehicle has crossed the assistance start line to ensure safety of the host vehicle nor an amount by which the host vehicle has crossed the assistance start line at the point.

4. A vehicle driver assistance method for providing a warning or steering assistance for reducing deviation of a host vehicle from a lane, the vehicle driver assistance method being configured to start the warning or the steering assistance when the host vehicle reaches an assistance start line set along a lane marking defining the lane, the vehicle driver assistance method comprising:
storing, as a deviation point, a point at which the host vehicle has reached the assistance start line, and storing, as a deviation amount, an amount by which the host vehicle has crossed the assistance start line at the deviation point; and
when the host vehicle is traveling at the deviation point and the number of times the host vehicle has reached the assistance start line at the deviation point is a predetermined number of times or more, shifting the assistance start line in a direction away from a center of the lane according to the stored deviation amount.

5. A non-transitory storage medium storing a vehicle driver assistance program configured to provide a warning or steering assistance for reducing deviation of a host vehicle from a lane, the vehicle driver assistance program being configured to start the warning or the steering assistance when the host vehicle reaches an assistance start line set along a lane marking defining the lane, wherein the vehicle driver assistance program is configured to
store, as a deviation point, a point at which the host vehicle has reached the assistance start line, and store, as a deviation amount, an amount by which the host vehicle has crossed the assistance start line at the deviation point, and
when the host vehicle is traveling at the deviation point and the number of times the host vehicle has reached the assistance start line at the deviation point is a predetermined number of times or more, shift the assistance start line in a direction away from a center of the lane according to the stored deviation amount.
